(19) United States
(12) Patent Application Publication
(10) Pub. No.: US 2014/0101561 A1
(43) Pub. Date: Apr. 10, 2014

(54) USER TERMINAL APPARATUS AND UI PROVIDING METHOD THEREOF, AND SERVER AND CONTROL METHOD THEREOF

(71) Applicant: Samsung Electronics Co. Ltd., Suwon-si (KR)

(72) Inventors: Bo-seok MOON, Gunpo-si (KR); Hee-won JUNG, Suwon-si (KR)

(73) Assignee: Samsung Electronics Co. Ltd., Suwon-si (KR)

(21) Appl. No.: 14/046,392

(22) Filed: Oct. 4, 2013

(30) Foreign Application Priority Data
Oct. 4, 2012 (KR) 10-2012-0110335

(51) Int. Cl. H04W 4/00

(52) U.S. Cl. CPC H04W 4/008
USPC 715/738

(57) ABSTRACT

A method for providing a User Interface (UI) of a user terminal apparatus is provided. The method includes when the user terminal apparatus is tagged with an external object including a short-range wireless communication tag, receiving object information stored in the short-range wireless communication tag, determining a category that the external object belongs to based on the received object information, generating a UI based on the external object using a UI element related to the determined category, and displaying the generated UI.

### CROSS-REFERENCE TO RELATED APPLICATION(S)

This application claims the benefit under 35 U.S.C. §119(a) of a Korean patent application filed on Oct. 4, 2012 in the Korean Intellectual Property Office and assigned Serial No. 10-2012-0110335, the entire disclosure of which is hereby incorporated by reference.

### TECHNICAL FIELD

The present disclosure relates to a user terminal apparatus and a User Interface (UI) providing method thereof, and a server and a control method thereof. More particularly, the present disclosure relates to a user terminal apparatus which uses short-range wireless communication and a UI providing method thereof, and a server and a control method thereof.

### BACKGROUND

As communication technology has evolved, users have become able to obtain a variety of information more easily. For example, users may now receive information from web servers through the Internet, or may receive information from various information providing sources using a short-range wireless communication method.

In particular, a Near Field Communication (NFC) method, which is a short-range wireless communication method, enables two or more terminals to exchange data when the terminals approach one another within a short distance and without any external influence. The NFC refers to non-contact wireless communication technology that can transmit data within a short distance at low power using RFID technology using a frequency of 13.56 MHz.

Therefore, a need exists for an improved method of utilizing information which is collected through various routes, such as the Internet or NFC, and in various ways, according to users' needs.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a user terminal apparatus which can provide a User Interface (UI) satisfying a user's needs based on information collected in a short-range wireless communication method, and a UI providing method thereof, and a server and a control method thereof.

In accordance with an aspect of the present disclosure, a method for providing a UI of a user terminal apparatus is provided. The method includes when the user terminal apparatus is tagged with an external object in the form of a short-range wireless communication tag, receiving object information stored in the short-range wireless communication tag, determining a category that the external object belongs to based on the received object information, generating a UI based on the external object using a UI element related to the determined category, and displaying the generated UI.

The generating of the UI may include requesting the UI element related to the determined category from an external server, and generating the UI using the UI element received from the external server.

The generating of the UI may include generating the UI by combining the received UI element with a pre-stored UI specification.

The generating of the UI may include generating the UI by combining the received UI element with a UI specification which is received from the external server.

The UI element may vary according to the category.

The UI element may include at least one of an image related to the external object, a text, and link information for providing information on the external object.

The external object may be at least one of terminal apparatuses which are provided in a purchasable product and a specific place.

In accordance with another aspect of the present disclosure, a control method of a server is provided. The control method includes receiving object information which is obtained by tagging with an external object in the form of a short-range wireless communication tag from a user terminal apparatus, determining a category that the external object belongs to based on the received object information, and transmitting information on a UI element related to the determined category to the user terminal apparatus.

The transmitting of the information to the user terminal apparatus may include determining a UI element related to the category based on information in which a UI element is mapped according to a category, and transmitting information on the determined UI element to the user terminal apparatus.

The UI element may include at least one of an image related to the external object, a text, and link information for providing information on the external object, and may vary according to the category.

In accordance with another aspect of the present disclosure, a user terminal apparatus is provided. The user terminal apparatus includes when the user terminal apparatus is tagged with an external object in the form of a short-range wireless communication tag, a communicator configured to receive object information stored in the short-range wireless communication tag, a UI processor configured to generate a UI on the external object, a controller configured to determine a category to which the external object belongs based on the received object information, and to control to generate a UI on the external object using a UI element related to the determined category, and a display configured to display the generated UI.

The controller may request the UI element related to the determined category from an external server, and may generate the UI using the UI element received from the external server.

The controller may control to generate the UI by combining the UI element with a pre-stored UI specification.

The controller may control to generate the UI by combining the UI element with a UI specification which is received from the external server.

The UI element may vary according to the category.

The UI element may include at least one of an image related to the external object, a text, and link information for providing information on the external object.

The external object may be at least one of terminal apparatuses which are provided in a purchasable product and a specific place.

In accordance with another aspect of the present disclosure, a server is provided. The server includes a communicator configured to receive object information which is obtained by tagging with an external object in the form of a short-range wireless communication tag from a user terminal apparatus, and a controller configured to determine a category that the external object belongs to based on the received object information, and to control to transmit information on a UI element related to the determined category to the user terminal apparatus.

The controller may determine a UI element related to the category based on information in which a UI element is mapped according to a category, and to control to transmit information on the determined UI element to the user terminal apparatus.

The UI element may include at least one of an image related to the external object, a text, and link information for providing information on the external object, and may vary according to the category.

According to the above-described embodiments, a UI screen satisfying a user's needs may be provided

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a user terminal apparatus according to an embodiment of the present disclosure;

FIG. 2 is a view illustrating a configuration of a User Interface (UI) providing system according to an embodiment of the present disclosure;

FIG. 3 is a block diagram illustrating a configuration of a user terminal apparatus according to an embodiment of the present disclosure;

FIG. 4 is a block diagram illustrating a configuration of a user terminal apparatus, such as the user terminal apparatus of FIG. 3, according to an embodiment of the present disclosure;

FIG. 5 is a view illustrating a software configuration stored in a storage unit according to an embodiment of the present disclosure;

FIG. 6 is a block diagram illustrating a configuration of a server according to an embodiment of the present disclosure;

FIG. 7 is a view illustrating a control method of a user terminal apparatus according to an embodiment of the present disclosure;

FIGS. 8A, 8B, 8C, and 8D are views illustrating examples of UI specifications and UI elements according to various embodiments of the present disclosure;

FIGS. 9, 10, 11, 12, and 13 are views illustrating a UI providing method according to various embodiments of the present disclosure;

FIG. 14 is a flowchart illustrating a UI providing method of a user terminal apparatus according to an embodiment of the present disclosure; and

FIG. 15 is a flowchart illustrating a control method of a server according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

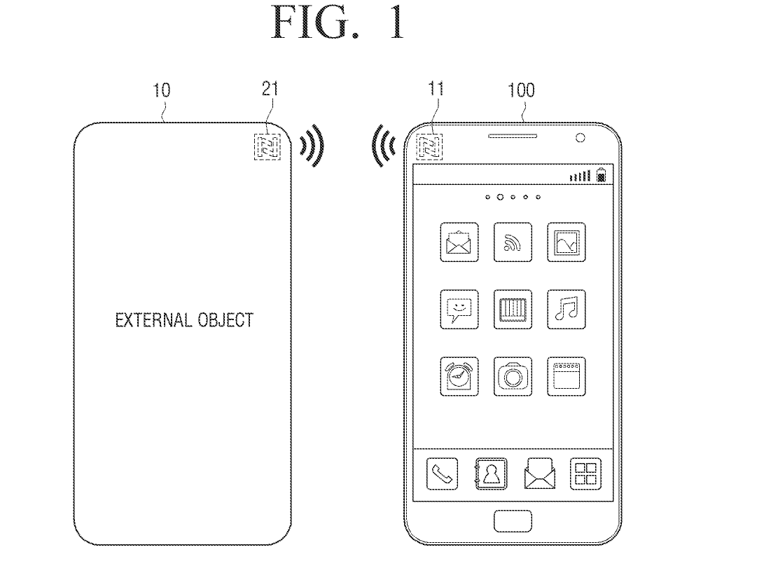

FIG. 1 is a view illustrating a user terminal apparatus according to an embodiment of the present disclosure.

Referring to FIG. 1, a user terminal apparatus 100 may be implemented by using various kinds of apparatuses which are portable and are equipped with a display function, such as a mobile phone including a smartphone, a Portable Multimedia Player (PMP), a Personal Digital Assistant (PDA), a tablet PC, and a navigation system.

In particular, the user terminal apparatus 100 may be implemented by an apparatus that can perform short-range wireless communication with an external object 10.

The external object 10 recited herein may be an information providing source that provides various data. More specifically, the external object 10 may be provided with a short-range wireless communication tag and thus may transmit data recorded on the short-range wireless communication tag to the user terminal apparatus 100 when the user terminal apparatus 100 is located within a communicable range. The short-range wireless communication will be explained below.

The data recorded on the short-range wireless communication tag may include a variety of information according to an external object.

For example, when the external object 10 is a short-range wireless communication tag which is attached to a specific place, an advertising leaflet on a specific place, or a location of a specific place on a map, the data recorded on the short-range wireless communication tag may include a variety of information on an address of the specific place, a place name, a store name, business hours, a telephone number, Global Positioning System (GPS) information, history, an admission fee, an event schedule, an image related to the specific place, an Uniform Resource Locator (ULR) link address, and subsidiary facilities (for example, a parking lot, a famous restaurant, and a tourist spot).

The place may include all places to which the user can go on foot or by car, such as a mart, a gas station, an amusement park, a subway station, a bus station, a museum, a historic site, a hospital, a department store, a company, an apartment, and a building.

When the external object 10 is a short-range wireless communication tag attached to a specific product, an advertising leaflet on the specific product, or a display stand of the specific product, the data recorded on the short-range wireless communication tag may include a product name, a date of manufacture, an expiry date, a manufacturer, and a URL link address related to the product.

The product recited herein may include any article which can be manufactured by fabricating a specific material, such as food, clothing, home appliances, cars, or the like.

The user terminal apparatus 100 may obtain data from the external object 10. In this case, the user terminal apparatus 100 may collect data in various ways.

For example, the user terminal apparatus 100 may obtain data from the external object 10 in a short-range wireless communication method. In this case, the user terminal apparatus 100 may include a short-range wireless communication reader. Accordingly, the user terminal apparatus 100 may read out data from the short-range wireless communication tag by accessing the external object 10 to which the short-range wireless communication tag 11 is attached at a short distance. The accessing at the short distance including tagging and letting at least one of the short-range wireless communication tag and the short-range wireless communication reader move to the other side and be located within a communicable range. When the short-range wireless communication reader is located within the communicable range, it may read out data recorded on the short-range wireless communication tag.

As an example of the short-range wireless communication method, Near Field Communication (NFC) may be used. The NFC is a non-contact short-range wireless communication method that uses the 13.56 Mz frequency band. In the NFC, a plurality of terminals may exchange data with one another when they approach each other within a short distance, such as about 10 cm. Another example of the short-range wireless communication method is a bar code method and a QR code method.

The collected data may vary according to the external object 10 with which the user terminal apparatus 100 communicates. That is, when the user terminal apparatus 100 receives data from a short-range wireless communication tag which is attached to a specific place, the collected data may include a variety of information related to the specific place, and, when the user terminal apparatus 100 receives data from a short-range wireless communication tag which is attached to a specific product, the collected data may include a variety of information related to the specific product.

The user may directly input information related to a specific place or a specific product to the user terminal apparatus 100. For example, the user may retrieve information on a specific place or a specific product through a communication network such as the Internet using the user terminal apparatus 100.

In an embodiment, the user terminal apparatus 100 may include a wireless communication module such as Wi-Fi, Zigbee, and Bluetooth, and may receive data by communicating with the external object 10 wirelessly. In this case, the external object 10 may separately include a wireless communication module (not shown) such as Wi-Fi, Zigbee, and Bluetooth to communicate with the user terminal apparatus 100. As another example, the user may connect an external storage medium such as a Universal Serial Bus (USB) memory or a memory card, or an electronic apparatus such as a PC, a laptop PC, a tablet PC, a mobile phone, and a navigation apparatus to the user terminal apparatus 100, and may transmit data stored in the external storage medium or the electronic apparatus to the user terminal apparatus 100.

As described above, the user terminal apparatus 100 may collect a variety of information related to a specific product or a specific place in various methods. The user terminal apparatus 100 may store the data collected in various methods. To achieve this, the user terminal apparatus 100 may include a Hard Disk Drive (HDD) or various memories.

The user terminal apparatus 100 may provide a User Interface (UI) screen corresponding to the external object 10 using the information which is obtained from the external object 10. More particularly, the user terminal apparatus 100 may provide a UI screen corresponding to a category that the external object 10 belongs to based on the information obtained from the external object 10. The UI screen is a screen for providing information on the external object to the user and may be provided in various forms according to the information received from the external object. To achieve this, the user terminal apparatus 100 may perform internal data search based on the information received from the external object 10, or may transmit the received information to a server (not shown) and may receive corresponding information from the server (not shown).

Hereinafter, a relationship between a user terminal apparatus 100 and a server (not shown) will be explained.

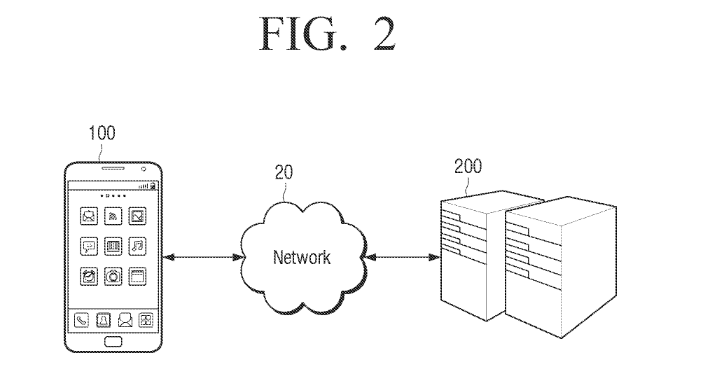

FIG. 2 is a view illustrating a configuration of a UI providing system according to an embodiment of the present disclosure.

Referring to FIG. 2, the UI providing system includes a user terminal apparatus 100 and a server 200.

The user terminal apparatus 100 transmits information obtained from an external object 10 (see FIG. 1) to the server 200 over a network 20. In this case, the obtained information may include different information according to the external object. This has been described above in FIG. 1 and thus a redundant explanation is omitted.

More specifically, the user terminal apparatus 100 may transmit the information which is obtained by tagging with the external object 10 to the server 200 as it is, or may extract specific information from the obtained information and may transmit the specific information to the server 200.

The user terminal apparatus 100 may communicate with the server 200 using the Internet. The user terminal apparatus 100 may transmit a variety of information included in the data obtained from the external object 10 to the server 200, and may receive information related to the transmitted information from the server 200. The information received from the server 200 may be UI information that is necessary for providing a UI screen corresponding to the external object 10, for example, a UI element, content on the UI element, and a UI specification.

The server 200 may retain the variety of information as a database, and may provide the variety of information according to a request of the user terminal apparatus 100. The server 200 may be implemented by using an external server which is provided separately from the user terminal apparatus 100. In an embodiment, the server 200 may be implemented by using an embedded server in the user terminal apparatus 100. Also, the server 200 may communicate with a separate information providing server (not shown) and may forward a variety of information to the user terminal apparatus 100.

More particularly, the server 200 may map a UI element of each category for identifying each product or place, a content on each element, and relevant server information for obtaining each piece of content according to a category or a product/place, and may store the mapped information.

Accordingly, the server 200 may provide a UI element corresponding to the object information received from the user terminal apparatus 100, content for each UI element, or a UI specification according to a request of the user terminal apparatus 100.

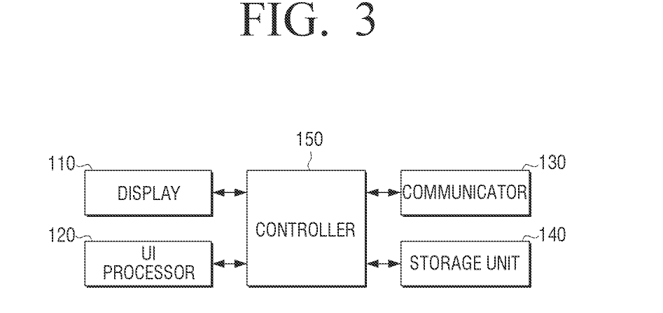

Hereinafter, configurations of a user terminal apparatus and a server will be explained with reference to FIGS. 3 to 6.

FIG. 3 is a block diagram illustrating a configuration of a user terminal apparatus according to an embodiment of the present disclosure.

Referring to FIG. 3, a user terminal apparatus 100 includes a display 110, a UI processor 120, a communicator 130, a storage unit 140, and a controller 150.

The display 110 displays a screen. The screen recited herein may include an application execution screen including various objects such as an image, a moving image, and a text, and a Graphic User Interface (GUI) screen.

More particularly, the display 110 may display a UI screen generated by the UI processor 120 which will be described later.

The UI processor 120 may generate GUIs of various forms.

In an embodiment, the UI processor 120 may serve to process/generate various UI screens including an image, a text, and link information in a 2D or 3D format. The UI screen recited herein may be a screen related to information which is received by tagging with the external object 10 as described above.

The UI processor 120 may perform operations such as converting a UI element into 2D/3D, and adjusting transparency, color, size, shape, and location of the UI element, as well as highlighting and performing an animation effect.

The communicator 130 may communicate with a short-range wireless communication tag which is attached to external objects. Accordingly, the communicator 130 may include a short-range wireless communication reader. The short-range wireless communication reader reads out information recorded on the short-range wireless communication tag when the short-range wireless communication reader accesses external objects to which the short-range wireless communication tag is attached within a short distance, and provides the read-out information to the controller 150. The short-range wireless communication reader may include a radio frequency module and an antenna coil. The short-range wireless communication reader emits electromagnetic waves through the antenna coil. Accordingly, an electric current is induced in the short-range wireless communication tag (not shown) attached to the external object that is located within reach of the electromagnetic waves from the user terminal apparatus 100 in the electromagnetic induction method. Accordingly, an integrated circuit in the short-range wireless communication tag is driven and transmits an RF signal including stored data. The radio frequency module of the short-range wireless communication reader receives the RF signal through the antenna coil, demodulates and decodes the received RF signal, and detects data carried in the RF signal. However, the short-range wireless communication reader may include a short-range wireless communication module including a short-range wireless communication tag if necessary.

In an embodiment, the communicator 130 may communicate with the server 200 if necessary. In this case, the communicator 130 may include a communication module which is separate from the communication module for performing short-range wireless communication with the short-range wireless communication tag attached to the external objects.

The communicator 130 may communicate with the server 200 through a network using the corresponding communication module. For example, the communicator 130 may communicate with the server 200 using various service protocols such as a Transmission Control Protocol/Internet Protocol (TCP/IP), a Hypertext Transfer Protocol (HTTP), a Hypertext Transfer Protocol over Secure socket layer (HTTPS), a Simple Object Access Protocol (SOAP), and an XML Remote Procedure Call (XML-RPC).

More specifically, the communicator 130 transmits object information to the server 200 and may receive UI information corresponding to the object information from the server 200.

The storage unit 140 is a storage medium that stores various programs necessary for driving the user terminal apparatus 100, and may be implemented by using a memory or a Hard Disk Drive (HDD). For example, the storage unit 140 may include a Read Only Memory (ROM) to store a program for performing an operation of the controller 150 and a Random Access Memory (RAM) to temporarily store data generated by the performance of the operation of the controller 150. The storage unit 140 may further include an Electrically Erasable and Programmable ROM (EEPROM) to store various reference data.

More particularly, the storage unit 140 may store a variety of UI specification information to be displayed on the display 110. The UI specification may be a UI window, and a size, a location, color, and a type (an image, a text, etc.) of a button arranged in the UI window.

In an embodiment, the storage unit 140 may store a UI element corresponding to a product or place category. The UI element may be various UI menus such as an image item, a text item, and a link item constituting the UI screen.

The controller 150 controls an overall operation of the user terminal apparatus 100.

More specifically, when the user terminal apparatus 100 is tagged with the external object provided with the short-range wireless communication tag, the controller 150 may receive object information stored in the short-range wireless communication tag. In this case, the tagging may be performed by tagging the tag provided in the user terminal apparatus 100 with the tag provided in the external object as it is. However, the tagging may be performed when the user terminal apparatus 100 enters a tag reading mode through a specific UI menu provided by the user terminal apparatus 100. That is, the user may drive a specific application provided in the user terminal apparatus 100, and may perform tagging by entering a corresponding application screen.

In an embodiment, the external object recited herein may be at least one of terminal apparatuses that are provided in a purchasable product and a specific place as described above. The object information may have various forms according to a kind of the external object. For example, when the external object is a product, the object information may include a variety of information, such as a product name, a product code, a kind of a product, a size of a product, a color of a product, and an address of a relevant server. Also, when the external object is a terminal apparatus provided in a specific place, the object information may include information such as a place name, a place code, a location, business hours, a substitute place, and an address of a relevant server.

In an embodiment, the controller 150 may determine a category that the external object belongs to based on the received object information. For example, when object information on a “refrigerator name” or a “refrigerator code” is received, the controller 150 may determine that the corresponding object belongs to a home appliance category. More specifically, the controller 150 may determine that the received object information indicates the “refrigerator name” or the “refrigerator code” based on pre-stored information or information received from an external source. For example, when object information includes information indicating “Zipel 600”, the controller 150 may determine that the corresponding information indicates the product “refrigerator”. That is, information in which a general product name is mapped onto a brand name may be pre-stored or may be received from an external source.

In an embodiment, separate information for identifying a category, such as a flag, may be included in the object information besides the product name or the product code. For example, when flag information like “1010” is included in the object information, the controller 150 may determine that the object belongs to the “home appliance category” based on the corresponding flag information. In this case, the controller 150 may determine that the corresponding flag indicates the “home appliance category” based on pre-stored information or information received from an external source. That is, information in which a flag value is mapped according to a category may be pre-stored, or may be received from an external source.

In an embodiment, the controller 150 may determine a UI element related to the determined category. For example, when the determined category is the “home appliance category”, the controller 150 may determine a product image, a product name, a price, a product specification, may search for lowest price, may determine gift information, may add to cart, may determine maintenance information, or the like, as being relevant UI elements. Also, the controller 150 may determine only an additional menu other than general information on the object received by tagging with the external object as the UI element. For example, when the determined category is the “home appliance category”, the controller 150 may determine search for lowest price and add to cart as the UI element related to the corresponding category.

In an embodiment, when the product image, product name, price, product specification, search for lowest price, gift information, add to cart, and maintenance information are determined as the UI elements related to the “home appliance category”, the controller 150 may determine contents of the corresponding UI elements based on the received object information, the information pre-stored in the storage unit 140, and the information received from the server 200. Also, when the search for lowest price and add to cart are determined as the UI elements related to the home appliance category, the controller 150 may determine only contents of the corresponding UI elements and may provide contents included in the object information (for example, price, product name, etc.) as contents of the other UI elements on the UI screen in the form of a text or an image. The UI element recited herein may include at least one of an image related to the external object, a text, and link information providing information related to the external object. For example, when the determined category is the “home appliance category”, the product image may be provided in the form of an image, the product name, price, product specification, and gift information may be provided in the form of a text, and the search for lowest price and add to cart may be provided in the form of a link.

The UI elements for each category may be pre-stored or may be received from an external source. That is, the controller 150 may determine the UI elements related to the determined category based on pre-stored information, but, when corresponding information is not stored in the user terminal apparatus 100, the controller 150 may transmit information on the determined category to the external server 200 and may receive UI elements belonging to the corresponding category from the external server 200. The external server 200 may be implemented by using a cloud server that provides services on various products according to an embodiment of the present disclosure. However, this should not be considered as limiting and the external server 200 may be implemented by using a server that is separately run by a product provider of each product.

In an embodiment, the UI elements for each category may be updated according to an event. That is, when update information on the UI elements is received from a relevant server (not shown) or periodic polling is performed in the relevant server, the UI elements for each category may be updated. The relevant server may be implemented by using a cloud server or a separate server run by a product provider like the external server 200.

The controller 150 may generate a UI on the external object based on the determined UI elements and display the UI. More specifically, the controller 150 may generate a UI on the external object by combining the determined UI elements with a pre-stored UI specification. The UI specification recited herein may be size, location, color, and type (e.g., image, text, etc.) of a UI window and a button arranged in the UI window. In an embodiment, the UI specification may also be received from the external server 200.

In this case, the controller 150 may collect additional information based on the received object information and generate a UI menu, or may additionally generate a UI menu for each category even when there is no additional information in the received object information. For example, the controller 150 may collect data based on link information included in the received object information and generate a UI menu, or may receive data corresponding to the UI elements such as add to wish list and search for lowest price regardless of the received object information, and may generate a UI menu.

In an embodiment, the controller 150 may generate a UI by displaying an image or text included in the received object information on the UI screen as it is, and generating a button for a link for providing various additional functions such as an additionally collected function or a function additionally provided in the category and displaying a function name on the button.

In an embodiment, the controller 150 may perform a web search to obtain information on the UI elements. More specifically, the controller 150 may download image information and may provide homepage link information in the form of a button or an icon linked to corresponding information. In this case, the controller 150 may adjust the contents of the UI elements according to the corresponding UI specification, such as adjusting a size of the downloaded image, and may display the contents.

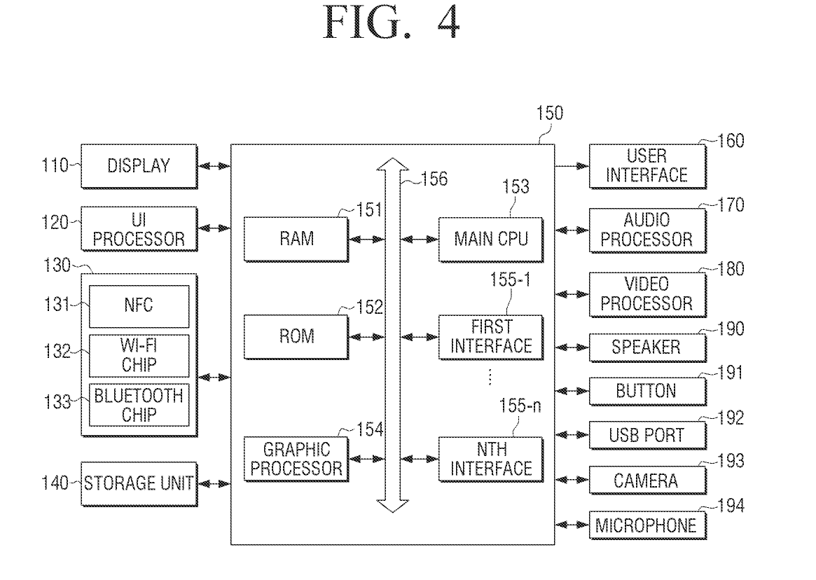

FIG. 4 is a block diagram illustrating a configuration of a user terminal apparatus, such as the user terminal apparatus of FIG. 3, according to an embodiment of the present disclosure.

Referring to FIG. 4, the user terminal apparatus 100 includes a display 110, a UI processor 120, a communicator 130, a storage unit 140, a controller 150, a user interface 160, an audio processor 170, a video processor 180, a speaker 190, a button 191, a USB port 192, a camera 193, and a microphone 194. From among the elements of FIG. 4, the same elements as those of FIG. 3 will not be explained again for the sake of brevity.

The display 110 may be implemented by using a Liquid Crystal Display (LCD) panel or an Organic Light Emitting Diode (OLED). However, this should not be considered as limiting. In an embodiment, the display 110 may be implemented by using a touch screen having a layered structure with a touch pad.

In an embodiment, the display 110 may be used as the user interface 160 as well as an output apparatus. The touch screen may be configured to sense touch input pressure as well as a touch input location and a touch area.

The communicator 130 is configured to communicate with various types of external apparatuses according to various communication methods. The communicator 130 may include various communication chips including an NFC chip 131, a Wi-Fi chip 132, and a Bluetooth chip 133.

The NFC chip 131, the Wi-Fi chip 132, and the Bluetooth chip 133 perform communication in the NFC method, the Wi-Fi method, and the Bluetooth method, respectively.

The NFC chip 131 is operated in the NFC method, which uses a frequency of 13.56 MHz from among various RF-ID frequency bands such as 135 kHz, 13.56 MHz, 433 MHz, 860960 MHz, and 2.45 GHz. Beside these, the communicator 130 may further include a wireless communication chip which communicates with external apparatuses according various communication standards such as IEEE, Zigbee, 3^{rd} Generation (3G), 3^{rd} Generation Partnership Project (3GPP), and Long Term Evolution (LTE).

The above-described operations of the controller 150 may be performed by a program which is stored in the storage unit 140. The storage unit 140 may store various data such as an Operating System (OS) software module for driving the user terminal apparatus 100, various applications, and various data and contents which are input or set while an application is executed.

When the UI providing service according to an embodiment of the present disclosure is implemented in the form of an application which is software directly used by the user on the OS, the storage unit 140 may store the corresponding application. In this case, the corresponding application may be provided, but not limited to, in the form of an icon interface on the screen of the user terminal apparatus 100.

The storage unit 140 may store information such as a UI specification and UI elements for each category for providing a UI corresponding to the external object according to an embodiment of the present disclosure.

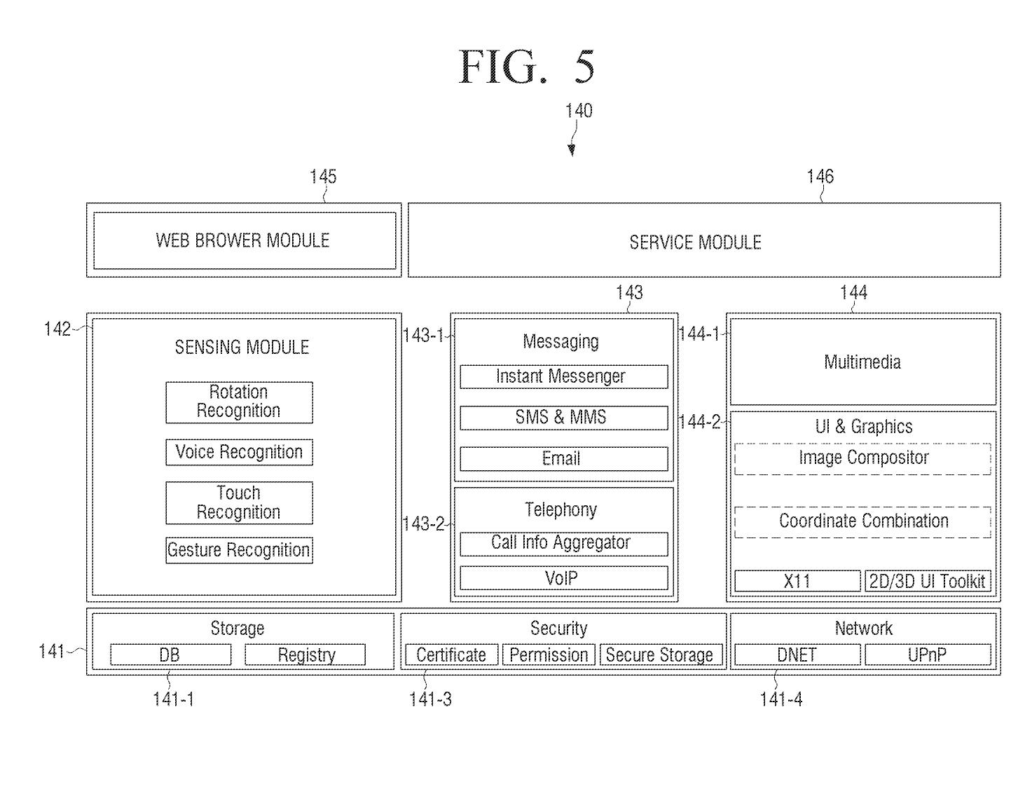

Various software modules stored in the storage unit 140 will be explained below with reference to FIG. 5.

The user interface 160 may receive various user commands.

More particularly, the user interface 160 may receive a user command to manipulate a specific button provided on the UI screen on the external object which is provided on the display 110 under the control of the controller 150.

When the UI corresponding to the external object is provided in the form of a specific application according to an embodiment of the present disclosure, the user interface 160 may receive a user command to manipulate the corresponding application.

The audio processor 170 is an element that processes audio data. The audio processor 170 performs various processing operations such as decoding, amplifying, and noise filtering with respect to audio data.

The video processor 180 is an element that processes video data. The video processor 180 may perform various image processing operations such as decoding, scaling, noise filtering, frame rate conversion, and resolution conversion with respect to video data.

The speaker 190 is an element that outputs various notice sounds or voice messages as well as various audio data processed by the audio processor 180.

The button 191 may be implemented by using various kinds of buttons, such as a mechanical button, a touch button, and a wheel, which are formed on a certain area of the user terminal apparatus 100, such as a front surface, a side surface, or a rear surface of an exterior body of the user terminal apparatus 100. For example, a button to turn on/off power of the user terminal apparatus 100 may be provided.

The USB port 192 may communicate with various external apparatuses or may perform charging through a USB cable.

The camera 193 is configured to capture a still image or a moving image under the control of the user. The camera 193 may be a plurality of cameras including a front camera and a rear camera.

The microphone 194 receives a user's voice or other sounds and converts them into audio data. The controller 130 may use a user's voice input through the microphone 194 for a call process or may convert it into audio data and store the audio data in the storage unit 140.

When the camera 193 and the microphone 194 are provided, the controller 130 may perform a control operation according to a user voice input through the microphone 194 or a user motion recognized by the camera 193. That is, the user terminal apparatus 100 may be operated in a motion control mode or a voice control mode. In the motion control mode, the controller 130 activates the camera 193 and captures a user, traces a change in the user motion, and performs a corresponding control operation. In the voice control mode, the controller 130 may perform voice recognition by analyzing a user voice input through the microphone and performing a control operation according to the analyzed user voice.

The user terminal apparatus 100 may further include various external input ports to connect the user terminal apparatus 100 to various external terminals such as a headset, a mouse, and a Local Area Network (LAN).

The controller 150 may control an overall operation of the user terminal apparatus 100 using various programs stored in the storage unit 140.

For example, the controller 150 may execute an application stored in the storage unit 140, may configure an execution screen thereof and display it, and may play back various contents stored in the storage unit 140. In an embodiment, the controller 150 may communicate with external apparatuses through the communicator 130.

More specifically, the controller 150 includes a Random Access Memory (RAM) 151, a Read Only Memory (ROM) 152, a main CPU 153, a graphic processor 154, first to nth interfaces 155-1˜155-n, and a bus 156.

The RAM 151, the ROM 152, the main CPU 153, the graphic processor 154, and the first to the nth interfaces 155-1˜155-n may be connected to one another through the bus 156.

The first to the nth interfaces 155-1˜155-n are connected to the above-described various elements. One of these interfaces may be a network interface which is connected to an external apparatus through a network.

The main CPU 153 accesses the storage unit 140 and performs booting using the O/S stored in the storage unit 140. The main CPU 153 performs various operations using the various programs, content, and data stored in the storage unit 140.

The ROM 152 stores a set of commands to boot the system. When a turn on command is input and power is supplied, the main CPU 153 copies the O/S stored in the storage unit 140 to the RAM 151 according to a command stored in the ROM 152, executes the O/S and boots the system. When the booting is completed, the main CPU 153 copies the various application programs stored in the storage unit 140 into the RAM 151, executes the application programs copied into the RAM 151 and performs various operations.

The graphic processor 154 may generate a screen including various objects such as an icon, an image, and a text using a calculator (not shown) and a renderer (not shown). The calculator calculates an attribute value such as a coordinate value, a shape, a size, and a color, or the like, of an object to be displayed according to layout of the screen using a control command received from an input apparatus 154. The renderer generates a screen of various layouts including objects based on the attribute values calculated by the calculator. The screen generated by the renderer is displayed on a display region of the display 110.

Although not shown, the user terminal apparatus 100 may include a sensor.

The sensor (not shown) may sense various manipulations such as a touch, a rotation, a tilt, a pressure, an approach, or the like, on the user terminal apparatus 100.

More particularly, the sensor (not shown) may include a touch sensor to sense touch. The touch sensor may be implemented by using a capacitive type or a resistive type of sensor. The capacitive type calculates touch coordinates by sensing minute electricity excited in a user's body when a part of the user's body touches the surface of the display 110, using a dielectric substance coated on the surface of the display 110. The resistive type includes two electrode plates, and, when a user touches a screen, calculates touch coordinates by sensing an electric current flowing due to contact between upper and lower plates at the touched point. As described above, the touch sensor may be embodied in various forms. Beside these, the sensor may further include a geomagnetic sensor to sense a rotation state and a moving direction of the user terminal apparatus 100, and an acceleration sensor to sense a degree of tilt of the user terminal apparatus 100.

For example, when a touch on a specific button provided on the UI screen is sensed by the sensor (not shown), the controller 150 may perform an operation corresponding to a function of the button, and, when a rotation from a portrait mode to a landscape mode is sensed by the sensor (not shown), the controller 150 may rescale or change the UI screen suitable for the portrait mode to be suitable for the landscape mode, and may display the UI screen.

In an embodiment, although the UI screen corresponding to each of the portrait mode and the landscape mode may be changed by resealing, information on the UI elements of the UI screen corresponding to each of the portrait mode and the landscape mode and size and location of the UI screen may be set separately.

In an embodiment, the controller 150 may additionally provide a UI window in the landscape mode. For example, when a UI window corresponding to a specific product is displayed in the portrait mode, a specific function button on the UI window (for example, add to wish list) is selected, and the portrait mode is changed to the landscape mode, the size of the UI window is resealed and displayed, and a window related to the selected specific function button may be additionally displayed.

FIG. 4 is a block diagram illustrating a detailed configuration of a user terminal apparatus, such as the user terminal apparatus of FIG. 3, according to an exemplary embodiment of the present disclosure.

Referring to FIG. 4, the figure illustrates elements of the user terminal apparatus 100 by way of an example. According to an embodiment of the present disclosure, some of the elements shown in FIG. 4 may be omitted or changed, and another element may be added. For example, the user terminal apparatus 100 may further include a Global Positioning System (GPS) receiver to receive a GPS signal from a GPS satellite and calculate a current position of the user terminal apparatus 100, and a Digital Multimedia Broadcasting (DMB) receiver to receive a DMB signal and processes the same.

FIG. 5 is a view illustrating a software configuration stored in a storage unit according to an embodiment of the present disclosure.

Referring to FIG. 5, the storage unit 140 may store software including a base module 141, a sensing module 142, a communication module 143, a presentation module 144, a web browser module 145, and a service module 146.

The base module 141 refers to a module which processes signals transmitted from each piece of hardware included in the user terminal apparatus 100 and transmits the signals to an upper layer module. The base module 141 includes a storage module 141-1, a security module 141-2, and a network module 141-3. The storage module 141-1 is a program module which manages a Database (DB) or a registry. The CPU 153 may access the database in the storage unit 140 using the storage module 141-1, and may read out various data. The security module 141-2 is a program module which supports certification for hardware, permission of a request, and a secure storage. The network module 141-3 is a module to support network connection, and includes a Distributed.net (DNET) module and a Universal Plug and Play (UPnP) module.

The sensing module 142 is a module which collects information from various sensors, and analyzes and manages the collected information. The sensing module 142 may include a face recognition module, a voice recognition module, a motion recognition module, and an NFC recognition module.

The communication module 143 is a module to communicate with an external apparatus. The communication module 143 includes a messaging module 143-1 such as a messenger program (e.g., an instant messenger program, etc.), a Short Message Service (SMS) and Multimedia Message Service (MMS) program, and an email program, and a telephony module 143-2 which includes a call information aggregator program module and a Voice over Internet Protocol (VoIP) module.

The presentation module 144 is a module which generates a display screen. The presentation module 144 includes a multimedia module 144-1 to reproduce multimedia content and output the multimedia content, and a User Interface (UI) rendering module 144-2 to process a UI and graphics. The multimedia module 144-1 may include a player module, a camcorder module, and a sound processing module. Accordingly, the multimedia module 144-1 generates a screen and a sound by reproducing various multimedia contents, and reproduces the same. The UI rendering module 144-2 may include an image compositor module to combine images, a coordinate combination module to combine coordinates on a screen to display an image and generate coordinates, an X11 module to receive various events from hardware, and a 2D/3D UI toolkit to provide a tool for configuring a UI of a 2D or 3D format.

The web browser module 145 is a module which performs web-browsing and accesses a web server. The web browser module 145 may include a web view module to render and view a web page, a download agent module to download, a bookmark module, and a web-kit module.

The service module 146 is a module that includes various applications to provide various services. More specifically, the service module 146 may include various program modules such as a navigation program, a content playback program, a game program, an e-book program, a calendar program, a notice management program, and other widgets, besides the UI providing program according to an embodiment of the present disclosure.

Although various program modules are illustrated in FIG. 5, some of the program modules shown in FIG. 5 may be omitted, changed or added according to a kind and a characteristic of the user terminal apparatus 100. For example, the storage unit 140 may further include a location-based module to support a location-based service in association with hardware such as a GPS chip.

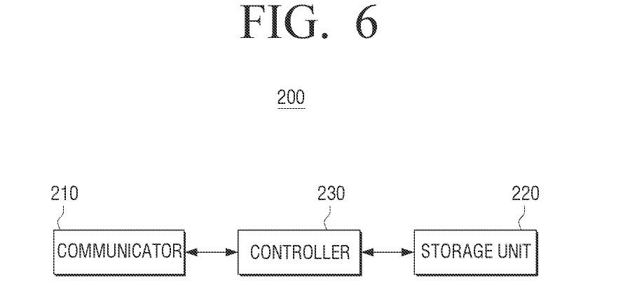

FIG. 6 is a block diagram illustrating a configuration of a server according to an embodiment of the present disclosure.

Referring to FIG. 6, the server 200 includes a communicator 210, a storage unit 220, and a controller 230.

The communicator 210 communicates with the user terminal apparatus 100. More specifically, the communicator 210 may communicate with the user terminal apparatus 100 through a network. The communicator 210 may communicate with the user terminal apparatus 100 using various service protocols described above when the communicator 130 of the user terminal apparatus 100 was described.

The storage unit 220 is a storage medium that stores various programs necessary for operating the server 200, and may be implemented by using a memory or an HDD.

More particularly, the storage unit 220 may store information on UI elements constituting various UI screens to be provided on the user terminal apparatus 100. More specifically, the storage unit 220 may store UI elements which correspond to a category that an external object belongs to and which are necessary for the user terminal apparatus 100 to provide a UI corresponding to the external object.

In an embodiment, the storage unit 220 may store a variety of UI specification information. The UI specification may be size, location, color, and type (image, text, etc.) of a UI window and a button arranged in the UI window. In this case, the storage unit 220 may store the UI specification information for displaying the UI elements corresponding to a category by mapping it onto a category.

That is, the server 200 may provide only the information on the UI elements when the UI specification information is stored in the user terminal apparatus 100, but may provide the UI specification information as well as the information on the UI elements according to circumstances.

The controller 230 may control an overall operation of the server 200.

More particularly, the controller 230 may provide information on the UI elements corresponding to a category to which the object information received from the user terminal apparatus 100 belongs to the user terminal apparatus 100 according to a request from the user terminal apparatus 100. In this case, when category information is included in the received object information, the controller 230 may determine only the UI elements that correspond to the corresponding category information, but, when the received object information does not include category information, the controller 230 may determine a category that the corresponding object belongs to based on the received object information, and may determine UI elements corresponding to the determined category.

In an embodiment, the controller 230 may provide content for each UI element to the user terminal apparatus 100. For example, when the UI element “search for lowest price” is provided, the controller 230 may include link information (for example, web page address information) for providing search for lowest price in the corresponding UI element and may provide the UI element. Also, when the UI element “store guide map” is provided, the controller 230 may include a map image for guiding to a store in the corresponding UI element and may provide the UI element.

In an embodiment, the controller 230 may provide UI specification information for providing UI elements corresponding to a corresponding category. For example, when UI elements “product image, product price, and wish list” are provided, the controller 230 may search for UI specification information for providing “image, text, and link information” from among pre-stored UI specification information and provide the UI specification information, or may generate appropriate UI specification and provide the UI specification.

In an embodiment, the controller 230 may perform a web search to obtain information on the UI elements, and may provide the information obtained by the web search to the user terminal apparatus 100.

In an embodiment, the controller 230 may update the UI elements for each category according to an event. That is, when update information on the UI elements is received from a relevant server (not shown), or when periodic polling is performed in the relevant server (not shown), the controller 230 may update the UI elements for each category. The relevant server (not shown) may be implemented by using a server which is run by a service provider of each product.

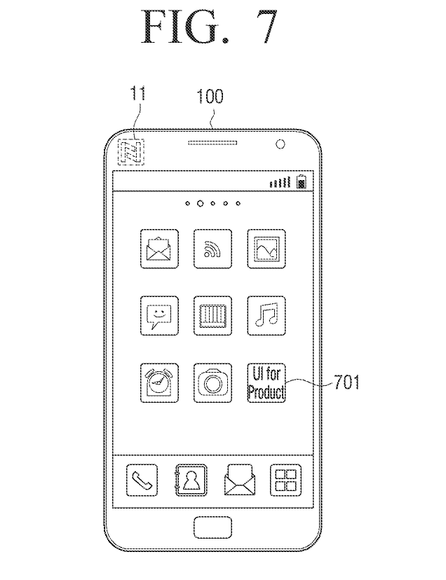

FIG. 7 is a view illustrating a control method of a user terminal apparatus according to an embodiment of the present disclosure.

Referring to FIG. 7, a UI providing method according to an embodiment of the present disclosure may be implemented in the form of an application.

That is, the user terminal apparatus 100 may provide a UI screen corresponding to the received object information by driving an application which is provided in the form of an icon interface, including an icon for a particular product 701, on the screen of the user terminal apparatus 100. For example, when the user terminal apparatus 100 including short-range wireless communication tag 11, is tagged with a short-range wireless communication tag provided in an external object after or before the user drives an application, the user terminal apparatus 100 may provide a UI screen corresponding to object information received by tagging.

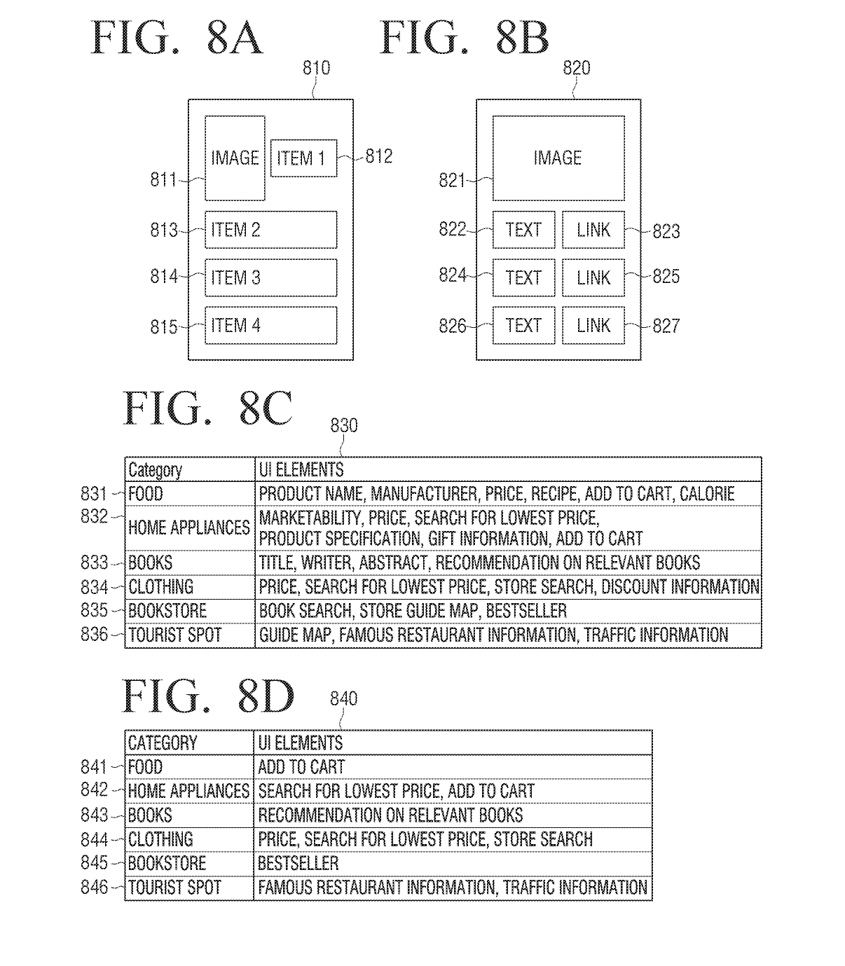

FIGS. 8A, 8B, 8C and 8D are views to illustrating examples of UI specifications and UI elements according to various embodiments of the present disclosure.

Referring to FIGS. 8A and 8B, the UI specification may have various forms.

More specifically, as shown in FIG. 8A, the UI specification 810 may include a layout having a size, location, and color of an image item 811 and general items 812 to 815.

As shown in FIG. 8B, the UI specification may include a layout such as size, location, and color of an image item 821, text items 822, 824, and 826, and link items 823, 825, and 827.

On the other hand, the UI specification information may be stored in the user terminal apparatus 100 or the server 200 as described above. In an embodiment, the UI specification information may be dynamically set according to the determined UI elements.

Referring to FIG. 8C, the figure illustrates examples of UI elements according to an embodiment of the present disclosure.

As shown in FIG. 8C, in the case of a food category 831, UI menus such as product name, price, recipe, calorie information, and add to cart may be already determined as the UI elements, and, in the case of a home appliance category 832, UI menus such as product name, price, search for lowest price, product specification, gift information, and add to cart may be already determined as the UI elements.

In the case of a book category 833, UI menus such as title, writer, abstract, and recommendation on relevant books may be already determined as the UI elements, and, in the case of a clothing category 834, UI menus such as price, search for lowest price, store search, and discount information may be already determined as the UI elements.

In the case of a bookstore category 835, UI menus such as book search, store guide map, and information on bestsellers/recommended books may be already determined as the UI elements, and, in the case of a tourist spot category 836, UI menus such as tourist spot guide map, information on famous restaurants, and traffic information may be already determined as the UI elements.

In the above-described embodiments of the present disclosure, an example of only one kind of external object is illustrated, and various UI menus corresponding to various kinds of external objects may be included.

The UI menus according to the kind of external object described in the above-described various embodiments of the present disclosure are merely examples and some UI menus may be omitted or another UI menu may be added. For example, the recipe may be omitted from the food category 831 and recommendation on a similar product may be added.

Referring to FIG. 8D, the figure illustrates examples of UI elements according to an embodiment of the present disclosure.

As shown in FIG. 8D, the elements belonging to each category may be already determined for only a function that can be additionally provided, except for the information on the external object received by tagging.

For example, in the case of a food category 841, a UI menu such as add to cart may be already determined as the UI element, in the case of a home appliance category 842, UI menus such as search for lowest price and add to cart may be already determined as the UI elements, and, in the case of a book category 843, a UI menu such as recommendation on relevant books may be already determined as the UI element.

In an embodiment, in the case of a clothing category 844, UI menus such as search for lowest price and store search may be already determined as the UI elements, in the case of a bookstore category 845, a UI menu such as information on bestsellers/recommended books may be already determined as the UI element, and, in the case of a tourist spot category 846, UI menus such as information on famous restaurants and traffic information may be already determined as the UI elements.

In this case, information such as a text and an image included in the object information may be provided on the UI screen as it is, and the menu additionally provided for each category may be displayed in the form of a button including a name.

On the other hand, the information on the UI elements for each category described above may be stored in the user terminal apparatus 100 or may be stored in the server 200. In an embodiment, UI elements corresponding to some categories may be stored in the user terminal apparatus 100 and UI elements corresponding to the other categories may be stored in the server 200. In an embodiment, information on the UI elements for each category that are not stored in the user terminal apparatus 100 or the server 200 may be dynamically generated through web search.

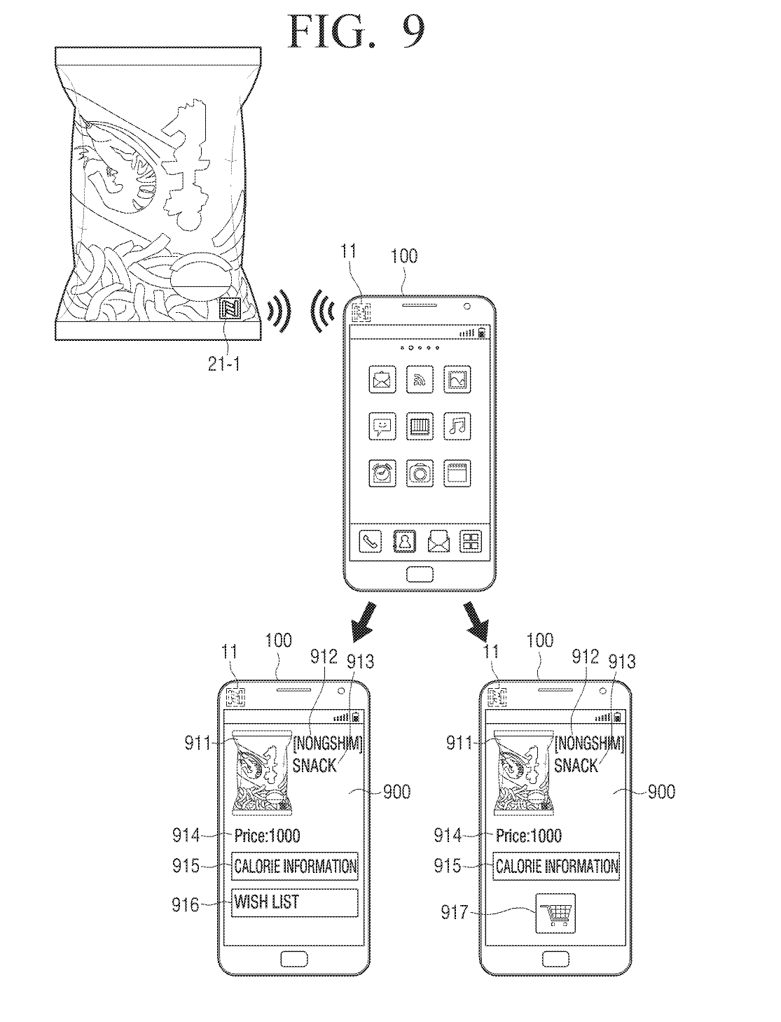

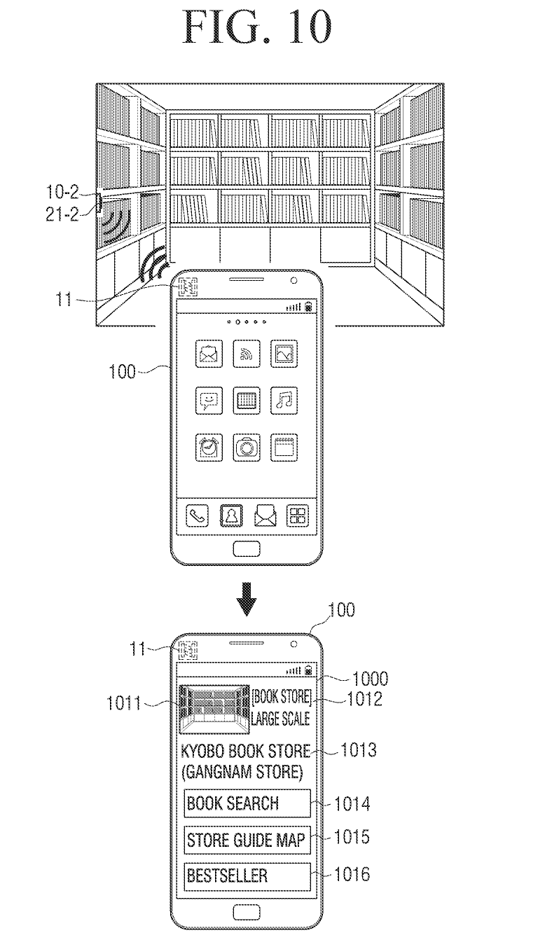

FIGS. 9, 10 11, 12, and 13 are views illustrating a UI providing method according to various embodiments of the present disclosure.

Referring to FIG. 9, it is assumed that the user terminal apparatus 100 is tagged with a short-range wireless communication tag 21-1 provided in a bag 10-1 of a shrimp snack, which is an external object, and thus receives object information stored in the short-range wireless communication tag. The user terminal apparatus 100 may communicate with the short-range wireless communication tag 21-1 provided in the bag 10-1 of the shrimp snack through a short-range wireless communication tag 11 provided therein.

In this case, the user terminal apparatus 100 may determine a category that “snack” belongs to, that is, a “food category” as shown in FIGS. 8A to 8D, based on the received object information. However, the UI elements for each category shown in FIGS. 8A to 8D are merely examples, and, when the category is further divided, the object may be classified as a “snack category”.

UI elements related to the determined “snack category” may be determined. More specifically, the user terminal apparatus 100 may determine UI elements related to the “snack category” based on information stored in the user terminal apparatus 100 or information received from the external server 200.

When “product image, manufacturer, product type, price, calorie information, and add to wish list” are determined as the UI elements related to the “snack category”, the user terminal apparatus 100 may generate a UI window by combining the UI elements with a UI specification appropriate for displaying the UI elements. The UI specification may be stored as default, may be selected from among pre-stored UI specifications based on the determined UI elements, or may be dynamically generated based on the determined UI elements.

On the other hand, content for each UI element may be included in the object information received by tagging, may be pre-stored in the user terminal apparatus 100, or may be received from the external server 200. For example, contents for “manufacturer 912, product type 913, price 914, and calorie information 915” may be included in the received object information. Product image 911 may be downloaded from a relevant server through link information included in the received object information. In an embodiment, a piece of content corresponding to “add to wish list”, that is, link information with a server providing a wish list service, may be stored in the user terminal apparatus 100. Accordingly, when a “wish list button” is generated in the UI window 900, a “wish list button 916” may be generated using corresponding link information. Likewise, a shopping cart 917 button may be included.

Referring to FIG. 10, it is assumed that the user terminal apparatus 100 is tagged with a short-range wireless communication tag 21-2 provided in a terminal 10-2 in a bookstore, which is an external object, and thus receives object information stored in the short-range wireless communication tag. The user terminal apparatus 100 may communicate with the short-range wireless communication tag 21-2 provided in the terminal 10-2 in the bookstore through a short-range wireless communication tag 11 provided therein.

In this case, the user terminal apparatus 100 may determine a category that the external object belongs to, that is, a “bookstore category” as shown in FIGS. 8A to 8D, based on the received object information.

The user terminal apparatus 100 may determine UI elements related to the determined “bookstore category”. More specifically, the user terminal apparatus 100 may determine the UI elements related to the “bookstore category” based on information stored in the user terminal apparatus 100 or information received from the external server 200.

When “place image, place name, place type, price, bookstore name (branch name), book search, store guide map, and bestsellers/recommended books” are determined as the UI elements related to the “bookstore category”, the user terminal apparatus 100 may generate a UI window by combining the UI elements with a UI specification appropriate for displaying the UI elements. The UI specification may be stored as default, may be selected from among pre-stored UI specifications based on the determined UI elements, or may be dynamically generated based on the determined UI elements.

In an embodiment, content for each UI element may be included in the object information received by tagging, may be pre-stored in the user terminal apparatus 100, or may be received from the external server 200. For example, contents for “place image 1011, place name/place type 1012, bookstore name (branch name) 1013” may be included in the received object information, but, contents corresponding to “book search 1014, store guide map 1015, and bestsellers/recommended books 1016”, that is, link information on a book search service, store guide map image information, and link information related to bestsellers/recommended books may be received from the server 200.

Although all of the UI menus provided on the UI windows 900 and 1000 are determined according to the category in FIGS. 9 and 10, this is merely an example. According to another embodiment of the present disclosure, information on the external object received by tagging may be displayed as it is and used to configure the UI window, and also, a UI element separately provided for a category that a corresponding external object belongs to may be added and used to configure the UI window.

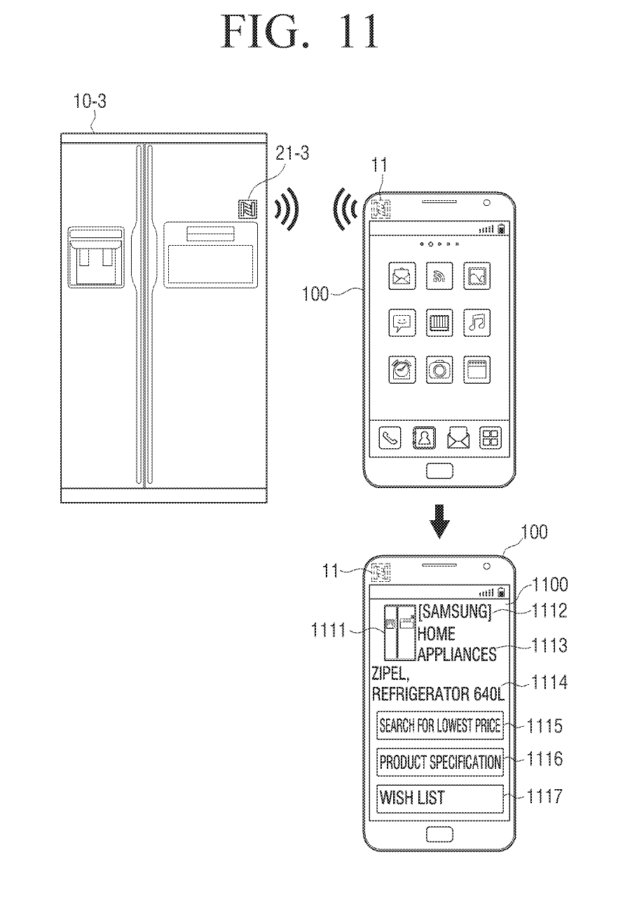

Referring to FIG. 11, it is assumed that the user terminal apparatus 100 is tagged with a short-range wireless communication tag 21-3 provided in a refrigerator 10-3, which is an external object, and thus receives object information stored in the short-range wireless communication tag. The user terminal apparatus 100 may communicate with the short-range wireless communication tag 21-3 provided in the refrigerator 10-3 through a short-range wireless communication tag 11 provided therein. In this case, the user terminal apparatus 100 or the server 200 may determine a category that the external object belongs to, that is, a “home appliance category” as shown in FIG. 8, based on the received object information.

UI elements related to the determined “home appliance category” may be determined. More specifically, the UI elements related to the “home appliance category” may be determined based on information stored in the user terminal apparatus 100 or information received from the external server 200.

For example, “search for lowest price, product specification, and add to wish list” may be determined as the UI elements related to the “home appliance category”, and product image, manufacturer, product type, and product name may be received through the object information and may not be included in the UI elements pre-determined for the category.

That is, product image 1111, manufacturer 1112, product category 1113, product name 1114 included in the received object information may be displayed on the UI screen 1000 as they are, and UI menus additionally collected regarding the category, that is, “search for lowest price 1115, product specification 1116, and wish list 1117” may be displayed in the form of buttons along with corresponding function names.

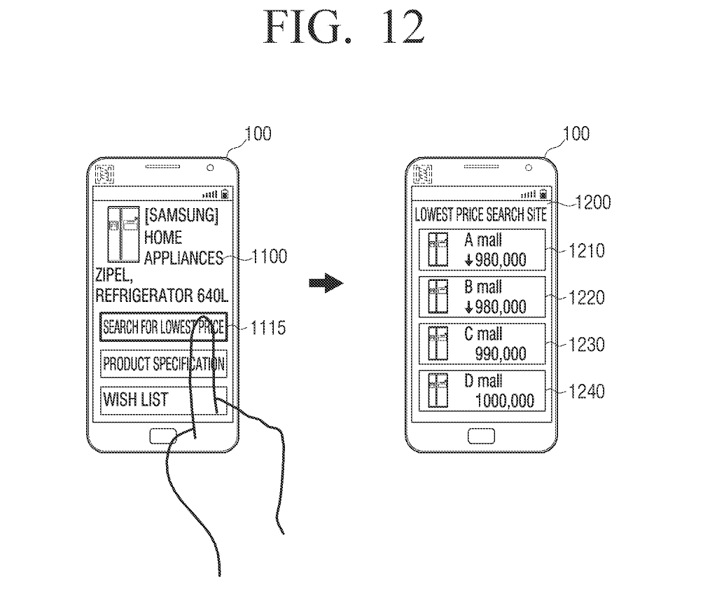

Referring to FIG. 12, the figure is a view illustrating a UI screen providing method according to an embodiment of the present disclosure.

Referring to FIG. 12, when a UI screen corresponding to an external object belonging to a specific category is displayed and a specific function button provided on the UI screen is selected, a screen corresponding to the function may be displayed.

For example, when a UI screen 1100 corresponding to a refrigerator belonging to a home appliance category is displayed and a button 1115 “search for lowest price” provided on the UI screen is selected, a web page 1200 linked with the corresponding button may be displayed. That is, a page showing a search result for a search for a lowest price on the refrigerator may be displayed. Search results 1210 to 1240 may also be provided.

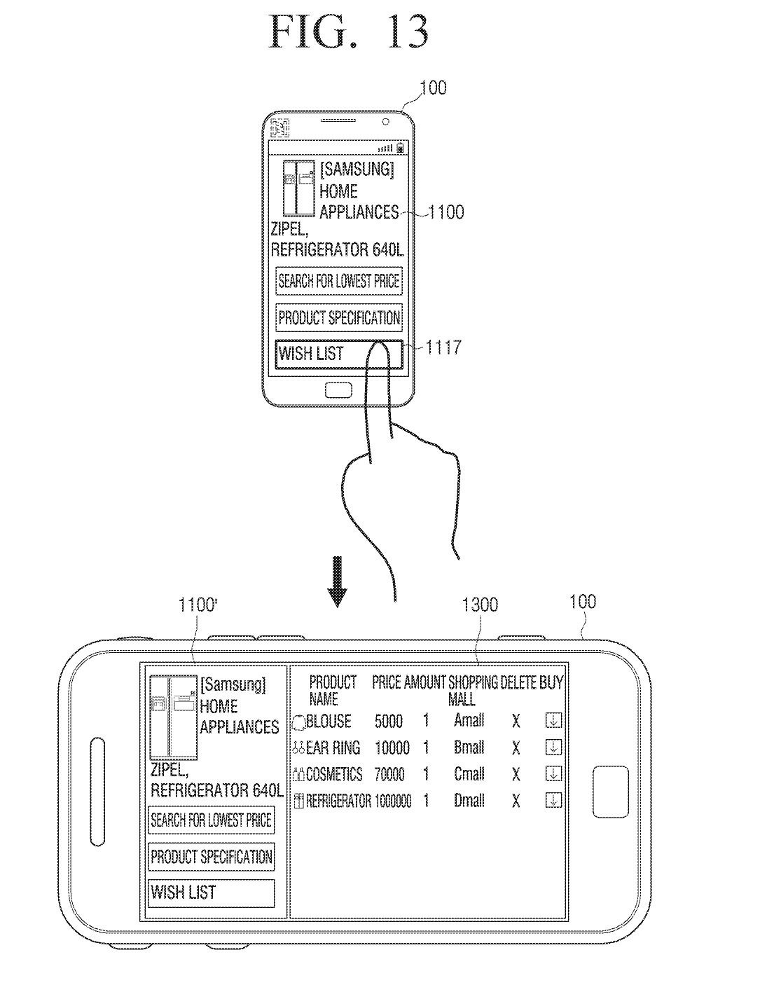

Referring to FIG. 13, the figure is a view illustrating a UI screen providing method according to another embodiment of the present disclosure.

Referring to FIG. 13, it is assumed that the user terminal apparatus 100 displays a UI screen 1100 corresponding to an external object belonging to a specific category in the portrait mode, a specific function button provided on the UI screen is selected, and the portrait mode is changed to the landscape mode.

In this case, a new window corresponding to a specific function corresponding to the selected button may be displayed in the landscape mode separately from the existing UI window.

For example, it is assumed that, when the user terminal apparatus 100 displays a UI screen corresponding to a refrigerator belonging to a home appliance category in the portrait mode, and a “wish list” button 1117 provided on the UI screen is selected, the portrait mode is changed to the landscape mode.

In this case, a window 1300 including a wish list page in which a corresponding product is added to the wish list 1117 according to a function corresponding to the selected “wish list” button may be displayed separately from the UI screen in the landscape mode. In this case, the UI screen 1100′ may be resealed to a size corresponding to some regions of the screen in the landscape mode and displayed as shown in FIG. 13.

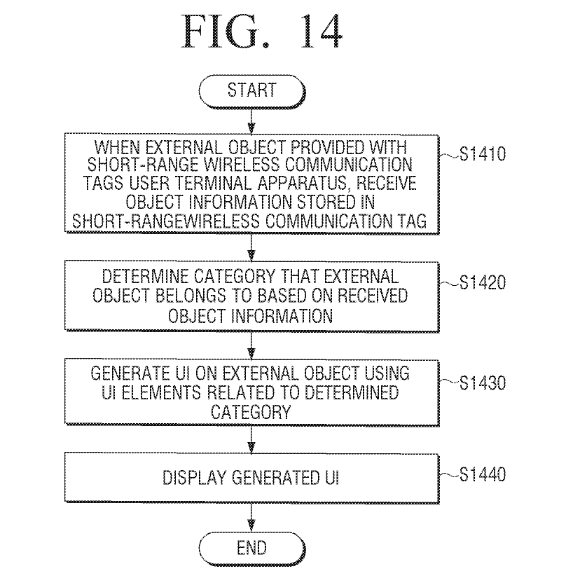

FIG. 14 is a flowchart illustrating a UI providing method of a user terminal apparatus according to an embodiment of the present disclosure.

Referring to FIG. 14, when the user terminal apparatus is tagged with an external object provided with a short-range wireless communication tag, the user terminal apparatus receives object information stored in the short-range wireless communication tag in operation S1410. The external object may be at least one of terminal apparatuses provided in a purchasable product and a specific place

The user terminal apparatus determines a category that the external object belongs to based on the received object information in operation S1420.

The user terminal apparatus generates a UI on the external object using UI elements related to the determined category in operation S1430.

After that, the user terminal apparatus displays the generated UI in operation S1440.

In operation S1430 of generating the UI, the user terminal apparatus may determine UI elements related to the determined category based on information in which UI elements are mapped according to a category and which is pre-stored in the user terminal apparatus.

In operation S1430 of generating the UI, the user terminal apparatus may request UI elements related to the determined category from the external server, and may receive the UI elements related to the category from the external server. In this case, the external server may determine the UI elements related to the determined category based on information in which UI elements are mapped according to a category, and may transmit information on the determined UI elements to the user terminal apparatus.

In operation S1430 of generating the UI, the user terminal apparatus may generate the UI by combining the UI elements with a pre-stored UI specification.

In operation S1430 of generating the UI, the user terminal apparatus may generate the UI by combining the UI elements with a UI specification received from the external server.

In operation S1440, the user terminal apparatus displays the generated UI.

In this case, the UI elements may be pre-stored in the user terminal apparatus or external server in a different form according to a category.

In an embodiment, the UI elements may include at least one of an image related to the external object, a text, and link information providing information on the external object.

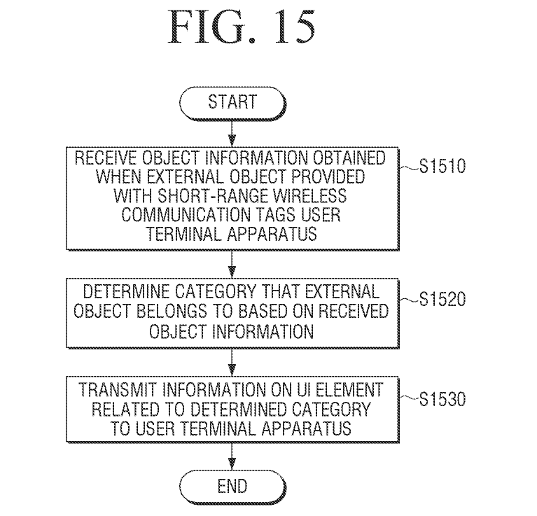

FIG. 15 is a flowchart illustrating a control method of a server according to an embodiment of the present disclosure.

Referring to FIG. 15, the server receives object information which is obtained when the user terminal apparatus is tagged with an external object provided with a short-range wireless communication tag from the user terminal apparatus in operation S1510.

The server determines a category that the external object belongs to based on the received object information in operation S1520.

The server transmits information on UI element(s) related to the determined category to the user terminal apparatus in operation S1530.

Accordingly, a UI screen satisfying user's needs can be provided.

In this case, in operation S1530 of transmitting the information on the UI elements to the user terminal apparatus, the server may determine the UI elements related to the determined category based on information in which UI elements are mapped according to a category, and may transmit information on the determined UI elements to the user terminal apparatus.

In this case, the UI elements may include at least one of an image related to the external object, a text, and link information providing information on the external object.

The control method according to various embodiments as described above may be implemented as a program and may be provided to the user terminal apparatus.

For example, a non-transitory computer readable medium which stores a program performing: when the user terminal apparatus is tagged with an external object provided with a short-range wireless communication tag, receiving object information stored in the short-range wireless communication tag, determining a category that the external object belongs to based on the received object information, generating a UI on the external object using a UI element related to the determined category, and displaying the generated UI, may be provided.

The non-transitory computer readable medium refers to a medium that stores data semi-permanently rather than storing data for a very short time, such as a register, a cache, and a memory, and is readable by an apparatus. More specifically, the above-described various applications or programs may be stored in a non-transitory computer readable medium such as a Compact Disc (CD), a Digital Versatile Disk (DVD), a hard disk, a Blu-ray disk, a Universal Serial Bus (USB), a memory card, and a Read Only Memory (ROM), and may be provided.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing a User Interface (UI) of a user terminal apparatus, the method comprising:
when the user terminal apparatus is tagged with an external object including a short-range wireless communication tag, receiving object information stored in the short-range wireless communication tag;
determining a category that the external object belongs to based on the received object information;
generating a UI based on the external object using a UI element related to the determined category; and
displaying the generated UI.

2. The method of claim 1, wherein the generating of the UI comprises:
requesting the UI element related to the determined category from an external server; and
generating the UI using the UI element received from the external server.

3. The method of claim 2, wherein the generating of the UI comprises generating the UI by combining the received UI element with a pre-stored UI specification.

4. The method of claim 2, wherein the generating of the UI comprises generating the UI by combining the received UI element with a UI specification which is received from the external server.

5. The method of claim 1, wherein the UI element varies according to the category.

6. The method of claim 1, wherein the UI element comprises at least one of an image related to the external object, a text, and link information for providing information on the external object.

7. The method of claim 1, wherein the external object is at least one of terminal apparatuses which are provided in a purchasable product and a specific place.

8. A control method of a server, the method comprising:
receiving object information which is obtained by tagging with an external object including a short-range wireless communication tag from a user terminal apparatus;
determining a category that the external object belongs to based on the received object information; and
transmitting information on a User Interface (UI) element related to the determined category to the user terminal apparatus.

9. The method of claim 8, wherein the transmitting of the information to the user terminal apparatus comprises:
determining a UI element related to the category based on information to which a UI element is mapped according to a category; and
transmitting information on the determined UI element to the user terminal apparatus.

10. The method of claim 8, wherein the UI element comprises at least one of an image related to the external object, a text, and link information for providing information on the external object, and varies according to the category.

11. A user terminal apparatus comprising:
when the user terminal apparatus is tagged with an external object including a short-range wireless communication tag, a communicator configured to receive object information stored in the short-range wireless communication tag;
a User Interface (UI) processor configured to generate a UI on the external object;
a controller configured to determine a category to which the external object belongs based on the received object information, and to control to generate a UI on the external object using a UI element related to the determined category; and
a display configured to display the generated UI.

12. The user terminal apparatus of claim 11, wherein the controller requests the UI element related to the determined category from an external server, and generates the UI using the UI element received from the external server.

13. The user terminal apparatus of claim 12, wherein the controller controls to generate the UI by combining the UI element with a pre-stored UI specification.

14. The user terminal apparatus of claim 12, wherein the controller controls to generate the UI by combining the UI element with a UI specification which is received from the external server.

15. The user terminal apparatus of claim 11, wherein the UI element varies according to the category.

16. The user terminal apparatus of claim 11, wherein the UI element comprises at least one of an image related to the external object, a text, and link information for providing information on the external object.

17. The user terminal apparatus of claim 11, wherein the external object is at least one of terminal apparatuses which are provided in a purchasable product and a specific place.

18. A server comprising:
a communicator configured to receive object information which is obtained by tagging with an external object including a short-range wireless communication tag from a user terminal apparatus; and
a controller configured to determine a category that the external object belongs to based on the received object information, and to control to transmit information on a User Interface (UI) element related to the determined category to the user terminal apparatus.

19. The server as claimed in claim 18, wherein the controller determines a UI element related to the category based on information in which a UI element is mapped according to a category, and controls to transmit information on the determined UI element to the user terminal apparatus.

20. The server as claimed in claim 18, wherein the UI element comprises at least one of an image related to the external object, a text, and link information for providing information on the external object, and varies according to the category.
